(19) United States
(12) Patent Application Publication
(10) Pub. No.: US 2023/0013576 A1
(43) Pub. Date: Jan. 19, 2023

(54) Method for managing a plurality of lists of items

(71) Applicant: Orange, lssy-Les-Moulineaux (FR)

(72) Inventors: François Toutain, Chatillon Cedex (FR); Emmanuel Le Huerou, Chatillon Cedex (FR)

(21) Appl. No.: 17/786,176

(22) PCT Filed: Dec. 15, 2020
(86) PCT No.: PCT/FR2020/052445

§ 371 Date: Jun. 16, 2022

(30) Foreign Application Priority Data
Dec. 18, 2019 (FR) FR1914762

(51) Int. Cl. G06Q 40/02; G06F 3/0482

(52) U.S. Cl. CPC G06Q 40/02; G06F 3/0482

(57) ABSTRACT

A method for managing, by a terminal, a plurality of lists of items that can be rendered by the terminal, each list of items of the plurality being different from a subset of another list of items of the plurality and includes at least one datum, called a balance datum. The plurality includes at least one first list with at least one item having at least one datum, called an action datum, and at least one datum, called an amount datum, the action datum being associated with at least one action.

### 1. FIELD OF THE INVENTION

The invention relates to the field of telecommunications and more particularly to a method making it possible to act on lists of data representing, for example, records of banking operations.

### 2. PRIOR ART

These days, banks offer their clients online services allowing them for example to perform transfers or consult records of operations from any computer or mobile terminal connected to the Internet. Although these online services are these days very widely used, they have changed very little with regard to the implementation of the so-called basic operations such as setting up a transfer or a withdrawal. In fact, in most of the proposed solutions, the user uses an assistant (graphical or vocal), for example transfer-dedicated, which will allow him or her to specify the account to be debited, the sum to be transferred and the account to be credited. In concrete terms, the user triggers the assistant by selecting the “make a new transfer” action situated under the “transfer” tab of his or her online service. This mode of operation makes it possible to assist the user in performing the action but at the cost of speed and simplicity. It has to be said that it is currently not possible to trigger, for example, a transfer directly from the record of operations of a bank account and to specify, for example for a transfer, several target accounts at the same time with a specific breakdown of a sum to be transferred to each of them. For example in the case of an automatic and percentage-wise breakdown, the user himself or herself must perform the calculation of the sums to be transferred to the target accounts and perform as many transfers as there are numbers of accounts to be credited. The same observation can also be made for withdrawals by supplying the account being debited from several savings accounts.

### 3. SUMMARY OF THE INVENTION

The invention aims to improve the state of the art and proposes a method for managing, by a terminal, a plurality of lists of items that can be rendered by said terminal, each list of items of said plurality being different from all the subsets of another list of items of said plurality and comprising at least one datum, called balance datum, said plurality comprising at least one first list with at least one item comprising at least one datum, called action datum, and at least one datum, called amount datum, said action datum being associated with at least one action, the method being characterized in that it comprises:
a step of triggering of said at least one action associated with said action datum of an item of said at least one first list;
a step of addition of at least one first new item in said first list of items and of at least one second new item in at least one second list of items of said plurality;
a step of calculation, as a function of said action, of a new value of said amount datum of said at least one first new item of said first list of items, of a new value of said amount datum of said at least one second new item of said at least one second list of items of said plurality, of a new value of said balance datum of said first list of items and of a new value of said balance datum of said at least one second list of items of said plurality;
a step of updating of said balance datum of said first list of items, of said balance datum of said at least one second list of items of said plurality, of said amount datum of said at least one second new item of said at least one second list of items of said plurality and of said amount datum of said at least one first new item of said first list of items.

Advantageously, this method allows a user to act directly from a first list of items/operations, for example a list of banking operations attached to a bank account, and to select a datum (for example a character string such as “debit” or a digit representing an amount) of an item in order to trigger an action associated with the datum such as a transfer for example. Once the action is triggered, the first list of items will have added to it one or more new items, for example debit operations/lines, and new items, for example credit operations/lines, are added to other lists such as lists of banking operations attached to target savings accounts. A calculation is also made to update the data of the lists and of the items affected/added.

It should be noted that each list of items cannot be one of the subsets of another list. In other words, the items which make up one list can not all be found in another list in the form of a subset.

A list is understood to be a series of elements, ordered or not, distinct or not, that make it possible to obtain a structured set such as a list of emails, for example time-stamped, SMSs, banking operations, names, etc. A list can have data which are specific to it and independent or not of the items of which it is composed, such as, for example, a name, a creation date, an identifier, a balance for example for a list of banking operations, etc. An item is understood to be an element of the list considered in isolation such as, for example, a transfer operation in a list of banking operations. Each item comprises data specific to it such as, for example, a name, a date, a value, an amount, etc.

Data are understood to be information that can be processed, exchanged, shared, retained, for example by a computer program and taking different forms: text (character string), numbers, images, sounds, etc.

According to a particular implementation of the invention, a method as described above is characterized in that the triggering step is followed by a step of rendering, to a user, of a set of data to be selected, called selection data, and a step of selection, by said user, of one of the selection data. Advantageously, this mode of implementation allows the user to select the target list or lists affected by the action associated with the action datum of an item, for example selected by the user. The lists proposed for selection by the method are lists deemed by the method as being compatible with the action.

In the case of a list of banking operations associated with bank accounts, the rendering step allows the user to, for example, specify the savings account or accounts to be credited via a transfer performed following the triggering of an action associated with the action datum of a current account item. The user can also specify a percentage or a fraction of the sum to be transferred to the savings account or accounts.

According to a particular mode of implementation of the invention, a method as described above is characterized in that the selection of one said selection datum by said user is performed via a voice command.

This mode of implementation allows a user to use a voice command to select a selection datum which is offered to him or her when he or she has triggered an action associated with an action datum of an item of a list. This mode of implementation is for example suited to the use of voice assistants or any other terminal capable of understanding and interpreting a voice command.

According to a particular mode of implementation of the invention, a method as described above is characterized in that the step of rendering of the lists of items is performed through a human-machine interface displayed on a screen of said terminal.

Advantageously, this mode of implementation allows the user to visualize the lists of items and the modifications made upon the triggering, by the user, of an action associated with the action datum of an item of a list.

According to a first variant of this particular embodiment of the invention, a method as described above is characterized in that said screen of said terminal is a touchscreen and in that the triggering step is performed via a press on said at least one action datum of said item of said at least one first list displayed on said screen.

This mode of implementation allows a user to use this method on any type of terminal that has a touchscreen, such as a smartphone, a personal computer, a terminal, for example an ATM (automated teller machine), etc. The triggering of an action associated with the action datum of an item of a list is then performed via a press on the action datum.

According to a second variant of this particular embodiment of the invention, a method as described above is characterized in that said screen of said terminal is a touchscreen and in that the triggering step is performed via a drag/drop of said item of said at least one first list displayed on said screen to an element of said human-machine interface symbolizing said at least one second list of items.

This embodiment allows the user to precisely identify the list or lists affected and to have a comprehensive and fluid user experience.

According to a particular mode of implementation of the invention, a method as described above is characterized in that the step of rendering of the lists of items is performed via a vocalization.

This mode of implementation allows a user to use this method via, for example, a voice assistant or any other terminal allowing the vocalization of the lists of items. This mode of implementation is for example suited to persons with a visual impairment or when the hands of the user are otherwise occupied, for example when driving a vehicle.

According to a particular mode of implementation of the invention, a method as described above is characterized in that the triggering step is performed via a voice command.

This mode of implementation allows a user to use a voice command to trigger an action associated with an action datum of an item of a list. This mode of implementation is for example suited to the use of voice assistants or any other terminal capable of understanding and interpreting a voice command.

According to a particular mode of implementation of the invention, a method as described above is characterized in that said plurality of lists of items corresponds to a plurality of lists of banking operations.

This mode of implementation allows a user to select an action datum of an item of a list of banking operations and to trigger an action, the action then affecting one or more other lists of banking operations in addition to that including the item for which the action datum was selected by the user.

According to a first variant of this particular embodiment of the invention, a method as described above is characterized in that said at least one action associated with said at least one action datum of an item of said first list of items is a bank transfer.

This embodiment is particularly suitable when the user wants to trigger a bank transfer to, for example, savings accounts, by selecting an action datum of an item of the list of banking operations of his or her current account.

According to a second variant of this particular embodiment of the invention, a method as described above is characterized in that said at least one action associated with said at least one action datum of an item of said first list of items is a bank withdrawal.

This embodiment is particularly suitable when the user wants to trigger a bank withdrawal from one or more savings account in order, for example, to supply the current account with a sum equivalent to a sum debited by a purchase. To do this, the user selects, for example, the action datum corresponding to the amount of the purchase, to the level of the item of the list of banking operations of his or her current account.

The invention relates also to a device for managing a plurality of lists of items, each list of items of said plurality being different from all the subsets of another list of items of said plurality and comprising at least one datum, called balance datum, said plurality comprising at least one first list with at least one item comprising at least one datum, called action datum, and at least one datum, called amount datum, said action datum being associated with at least one action, and characterized in that the device comprises:
a triggering module making it possible to trigger said at least one action associated with said action datum of an item of said at least one first list;
an addition module making it possible to add at least one first new item in said first list of items and at least one second new item in at least one second list of items of said plurality;
a calculation module making it possible to calculate, as a function of said action, a new value of said amount datum of said at least one first new item of said first list of items, a new value of said amount datum of said at least one second new item of said at least one second list of items of said plurality, a new value of said balance datum of said first list of items and a new value of said balance datum of said at least one second list of items of said plurality;
an updating module making it possible to update said balance datum of said first list of items, said balance datum of said at least one second list of items of said plurality, said amount datum of said at least one second new item of said at least one second list of items of said plurality and said amount datum of said at least one first new item of said first list of items.

The term module can correspond equally to a software component and to a hardware component or a set of hardware and software components, a software component itself corresponding to one or more computer programs or subroutines, or, more generally, to any element of a program that can implement a function or a set of functions as described for the modules concerned. Likewise, a hardware component corresponds to any element of a hardware set capable of implementing a function or a set of functions for the module concerned (integrated circuit, chip card, memory card, etc.).

It should be noted that the device can be a distributed device. The modules can therefore be distributed over several machines such as terminals, servers, etc., and communicate with one another through a communication network, such as the Internet network for example.

The invention relates also to a terminal, characterized in that it comprises a device as described previously.

The invention relates also to a computer program comprising instructions for implementing the above method according to any one of the particular embodiments described previously, when said program is run by a processor. The method can be implemented in various ways, notably in hard wired form or in software form. This program can use any programming language, and be in the form of source code, object code, or intermediate code between source code and object code, such as in a partially compiled form, or in any other desirable form.

The invention also targets a storage medium or information medium that can be read by a computer, and comprising instructions of a computer program as mentioned above. The storage media mentioned above can be any entity or device capable of storing the program.

For example, the medium can comprise a storage means, such as a ROM, for example a CD ROM or a microelectronic circuit ROM, or even a magnetic storage means, for example a hard disk drive. Also, the storage media can correspond to a transmissible medium such as an electrical or optical signal, which can be routed via an electrical or optical cable, wirelessly or by other means. The programs according to the invention can in particular be downloaded over a network of Internet type.

Alternatively, the storage media can correspond to an integrated circuit in which the program is incorporated, the circuit being adapted to execute or be used in the execution of the method concerned.

This device for managing a plurality of lists of items and this computer program have features and advantages similar to those described previously in relation to the method for managing a plurality of lists of items.

### 4. LIST OF FIGURES

Other features and advantages of the invention will emerge more clearly on reading the following description of particular embodiments, given as simple illustrative and nonlimiting examples, and the attached drawings, in which:

FIGS. 1a, 1b, 1c, 1d and 1e illustrate an example of environment of implementation of the invention according to a particular embodiment of the invention,

FIG. 2 illustrates the main steps of the method for managing a plurality of lists of items according to a particular embodiment,

FIG. 3 schematically illustrates an example of architecture of a device suitable for implementing the method for managing a plurality of lists of items according to a particular embodiment of the invention.

### 5. DESCRIPTION OF AN EMBODIMENT OF THE INVENTION

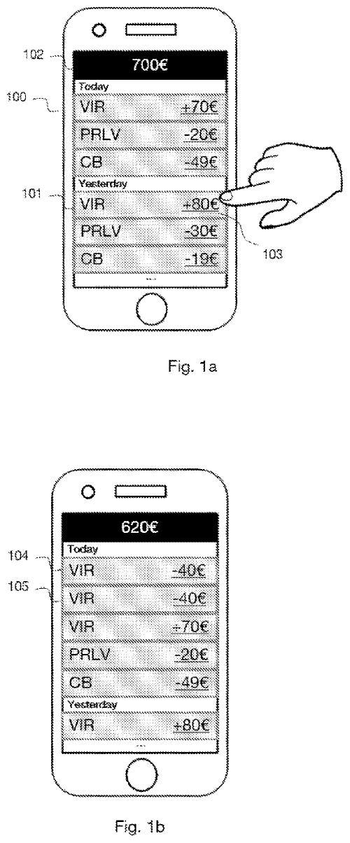

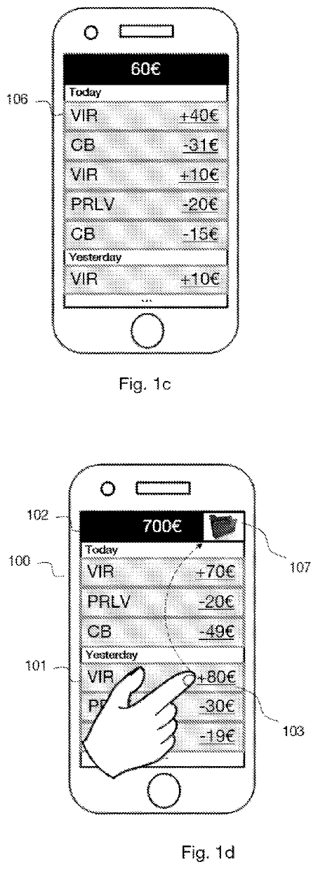

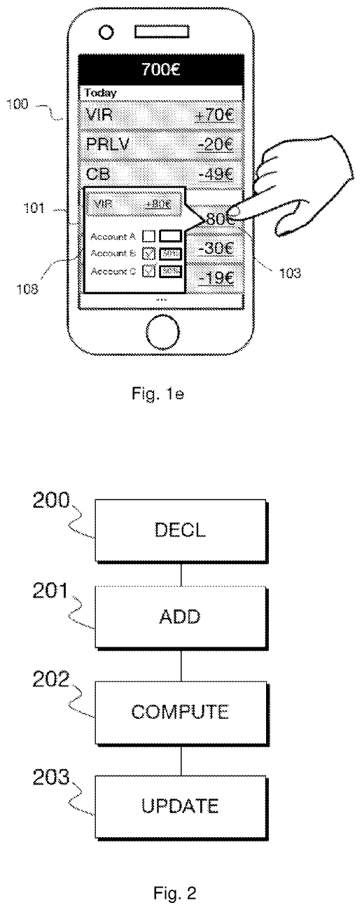

FIG. 1a illustrates a terminal 100 implementing the present invention/method according to a particular embodiment. It should be noted here that, although the terminal 100 illustrated in FIG. 1a corresponds here to a mobile terminal of smartphone type, the invention can be applied to any type of terminal having a screen and/or an audio module including, for example, a loudspeaker and/or a microphone, such as, for example, and in a nonlimiting manner, a tablet, an e-book reader, a game console, a television, an automated teller machine, a driving assist device, connected objects or even a personal computer. In the example described in support of FIG. 1a, the terminal 100 is a smartphone having a touchscreen adapted to locate, on the screen, contacts with an object or a part of the body of the user. A screen of capacitive or resistive type is, for example, suitable for implementing the invention. Conventionally, a user of the terminal 100 controls the execution of an operation by performing an action on a zone of the screen of the terminal 100. For that, the terminal interprets the action of the user as a function of what is displayed on the screen at the location where the action is performed. The action can, for example, be a press (a brief contact made on the screen), a double press, a long press, a drag/drop, a gesture made in contact with the screen representing, for example, a signature, or any other action involving a contact with the screen.

In the example described here, the terminal displays on a screen a list of banking operations 101, for example a drop-down list, of a bank account such as, for example, a current account. The list also comprises a value 102 comprising, for example, the balance of the current account. The balance represents the amount remaining at a given date on the current account. It is calculated by establishing the difference between the debit and credit elements of an account. Each element/item 101 of the list represents a banking operation such as a transfer, a withdrawal, a purchase by bank card, a purchase by check, etc. The elements/items of the list are, in this example, ordered and separated according to the date of the operation. Each element can include a text indicating the nature of the banking operation, the name of a person or of an institution, the amount (debited or credited), the date, links or zones that can be selected by the user or any other element related to the banking operation represented. The item 101 comprises two data indicating, respectively, the nature of the operation and the amount. The amount 103 is, here, an action datum within the meaning of the invention and is represented in the form of a hypertext link that can be selected by the user. When the latter selects, for example via a short press, the amount of the item, then he or she triggers an associated action such as a transfer and/or a withdrawal on at least one bank account in addition to the current account. In the case described here, the user, by selecting the amount “+80€”, triggers a transfer of 50% of the sum to two savings accounts. FIGS. 1b and 1c illustrate the result rendered to the user once the action is finished. In concrete terms, FIG. 1b represents the modified list of the banking operations of the current account with the addition of two new elements 104 and 105 respectively representing a sent transfer of 50% of the sum (i.e. of the 80€) to the first and the second savings accounts. The list is also updated with a new balance value calculated as a function of the transfer sent. Since the transfer is 80€, the balance value therefore changes to 620€ (700-80). FIG. 1c represents the modified list of the banking operations of one of the two savings accounts with the addition of an element 106 representing a received transfer of 50% of the sum represented by the amount selected by the user in FIG. 1a. Here too, the account balance is updated according to the amount of the transfer received. The same modifications/calculations are also added to the second savings account affected by the transfer.

It should be noted that the distribution of the sum represented by the amount selected by the user, that is to say the 80€, in the target savings accounts, can be automatic with, for example, a predefined amount or percentage of this sum for each account, the percentages being able to be a function of the number of target accounts. The predefined amounts or percentages can cover part or all of the sum of 80€. In the case where these are amounts which are predefined and the sum of the amounts exceed the 80€, then an error message is rendered graphically or vocally to the user.

It should also be noted that the selectable datum of an element of the list of banking operations can also be a specific character string such as “move”, an icon, an image, or any other element included in an element/item of a list or else the item/element itself.

According to a particular embodiment, the datum indicating the nature of the banking operation associated with the items 104, 105, 106 can be created as a function of the nature of the action (example: transfer, withdrawal, etc.), of a datum of the item 101 of an affected list datum, of the identity of the person who has triggered the action (for example one of the owners of the current account), etc.

In concrete terms, the datum indicating the nature of the operation of the item 106 can be the same datum as that indicating the nature of the operation of the item 101, or complemented with a datum such as the percentage indicating the pro rata of the initial sum received, or else complemented with the name of the person who has triggered the operation or even any combination of the data of the item 101 and of the data of the current account.

The identity of the person who has triggered the action can be established via the identifiers used to log on to an online banking service capable of providing lists of banking operations of the bank accounts of the user or via an authentication of the user by voice recognition.

According to a particular embodiment, the user can also trigger an action associated with an action datum of an element of the list of banking operations by selecting the datum and by dragging it then dropping it on a symbol such as, for example, an icon, an image or a zone of the screen representing one or more bank accounts. FIG. 1d illustrates an example of this particular embodiment linked to the environment described via FIGS. 1a, 1b and 1c. To trigger an action such as a transfer for example, the user selects then drags/drops the amount of 80€ on an icon 107 representing the two savings accounts.

Optionally, the triggering of an action associated with a datum of an item can be followed by a rendering to the user of a set of data to be selected. FIG. 1e illustrates an example of this embodiment. When the user selects an action datum of the item 101 such as, for example, the datum 103 representing the amount of 80€, then the method renders, for example via the display of a menu 108, a set of data to be selected. The user then has the possibility of selecting, for example, the target savings accounts for a transfer and the percentage distribution of the 80€ to the two savings accounts. The user can also input amounts to be transferred to each savings account to match the 80€ available. It should be noted that the bank accounts offered for the selection by the method are accounts that are compatible with the operation. The bank accounts proposed and/or their order can thus be rendered as a function of a history of account transactions. For example, if a savings account is regularly selected from the current account on the first days of each month, then the method will propose this savings account as a priority during this period, for example at the top of the list. A frequency criterion can also be applied. The more a savings account is selected, the stronger its priority will be and the more it will be proposed by the method.

According to a particular embodiment, when the user selects an action datum of an item representing a debit in a list of banking operations of a current account, such as, for example, the amount of “−60€”, that for example triggers a withdrawal of all or part of the 60€ on at least one savings account in order to supply the current account and cover the expenditure of 60€. In the case where the withdrawal is made on several savings accounts, the distribution of the sum to be withdrawn on the savings accounts and represented by the amount selected by the user, that is to say the 60€, can be automatic with, for example, a predefined amount or percentage of this sum for each account, the percentages being able to be a function of the number of accounts to be taken from. The predefined amounts or percentages can cover part or all of the sum of 60€. The distribution of the sum to be withdrawn can also be set up manually via the inputting of the percentage of the sum to be withdrawn or the inputting of amounts by the user via, for example, a menu displayed when the user selects the amount of “−60€”.

In the case where the sum withdrawn from a savings account exceeds the balance of the savings account, then an error message is rendered graphically or vocally to the user.

According to a particular embodiment, the selection by the user of an action datum of an item and consequently the triggering of the action (transfer and/or withdrawal) can be done via a voice command.

According to a particular embodiment, the selection by the user of a selection datum rendered, for example, through a graphic menu (FIG. 1e), can be made via a voice command.

According to a particular embodiment, the lists rendered by the terminal 100 can be voiced.

FIG. 2 illustrates steps of the method for managing a plurality of lists of items according to one of the particular embodiments of the invention presented previously, the method being executed on the mobile terminal 100.

In a first step 200, the method, following an event, triggers an action associated with an action datum of an item of a list of items displayed on a touchscreen of the terminal 100. The list of items is, for example, a list of banking operations of a current account of a user. The action datum is, for example, an amount of a banking operation such as, for example, the amount of a transfer received. The event is, for example, a short press on the amount displayed on the screen and representing the action datum.

The action triggered is, for example, an automatic transfer to three savings accounts of a predefined percentage of the amount of the transfer received.

In a second step 201, the method adds three new items/elements in the list of banking operations of the current account, each representing a debit transfer of a percentage of the amount of the transfer received, to one of the three savings accounts, that is to say one transfer for each savings account. The method then adds an item/element to each of the three savings accounts representing the transfer received and sent by the current account. It should be noted that the transfers of the sums from the current account to the three savings accounts can be performed by the terminal 100 itself or delegated to a banking server. In the case of a delegation to a banking server, a request is sent by the terminal to the banking server with the necessary information/data for the transfers to be able to be made.

In the step 202, the method calculates the new values of the data associated with the lists and with the items such as the data on balances of the lists, on amount of the items but also all the data affected by the action.

In the step 203, the method updates the lists and the items with the values calculated in the step 202. The duly modified/updated lists can then be rendered to the user.

According to a particular embodiment, the method can, at any moment, transmit information on the status of the lists and of the items and of their data to a server situated in a network, such as the amount and balance values, and the number of new items added in the lists. That for example allows the banking entries to be consolidated on the server of the bank.

According to another particular embodiment, all or part of the steps of the method can be divided up between the terminal 100 and a server situated in the network. That can, for example, be the case for a voice assistant which, when a list of banking operations is voiced, picks up a voice command stated by a user requesting the performance of an action linked to one of the action data voiced, the action for example being able to be a bank transfer. The method then invokes the server and delegates to it, for example, the calculation step 202.

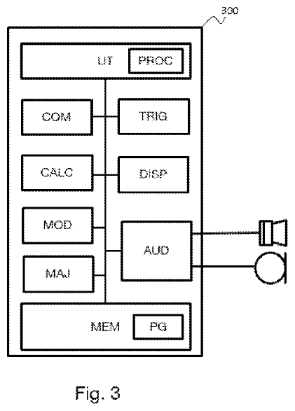

FIG. 3 illustrates a device 300 configured to implement the method for managing a plurality of lists of items according to a particular embodiment of the invention. According to a particular embodiment of the invention, the device 300 has the conventional architecture of a cell phone, of smartphone type, and notably comprises a memory MEM, a processing unit UT, equipped for example with a processor PROC, and driven by the computer program PG stored in memory MEM. The computer program PG comprises instructions for implementing the steps of the method for managing a plurality of lists of items as described previously, when the program is run by the processor PROC.

On initialization, the code instructions of the computer program PG are, for example, loaded into a memory before being executed by the processor PROC. The processor PROC of the processing unit UT notably implements the steps of the method for managing a plurality of lists of items according to any one of the particular embodiments described in relation to FIGS. 1a, 1b, 1c, 1d, 1e and 2, according to the instructions of the computer program PG.

The device 300 comprises a module TRIG capable of triggering an action associated with an action datum of an item of a list. The device can also comprise a display module (DISP) adapted to display graphic elements, and in particular display lists of elements/items and data associated with a list and/or with items. According to a particular embodiment, the module TRIG and the module DISP are combined in the form of a touchscreen, adapted to detect a contact between an object or a part of the body and trigger an action associated with an action datum of an item/element of a list based on the contacts made on the touchscreen.

The device can also comprise a module AUD capable of rendering, using sounds via, for example, a loudspeaker, lists of elements/items and data associated with a list and/or with items. According to a particular embodiment, the module TRIG and the module AUD are combined in the form of a voice recognition module capable of interpreting voice commands stated by a user and picked up, for example, via a microphone, and of triggering an action associated with an action datum of an item/element of a list based on the stated voice command.

The device 300 also comprises an addition module MOD capable of adding items in lists of items, a module CALC capable of calculating, as a function of the action triggered by a user, the values of the data of the lists and the values of the data of the items added by the module MOD, but also a module MAJ capable of updating the data of the lists and the data of the items for example before they are rendered to the user.

The device 300 can also comprise a communication module COM configured to set up communications with a network, for example an IP and/or circuit network. This module can for example be used when the device is incorporated in a mobile terminal and it communicates with a server in the network such as, for example, a banking server in order to transmit to it the values of the data of lists and of items and the updated lists corresponding, for example, to bank accounts.

According to a particular embodiment, the device can be incorporated in a terminal of smartphone type, a touch tablet, a personal computer, a control center of a home automation installation, a server, an onboard computer in a vehicle or even a voice assistant.

It goes without saying that the embodiment which has been described above has been given in a purely indicative and nonlimiting manner, and that many modifications can easily be made by the person skilled in the art without in any way departing from the scope of the invention.

1. A method comprising:
managing, by a terminal, a plurality of lists of items that can be rendered by said terminal, each list of items of said plurality being different from all subsets of another list of items of said plurality and comprising at least one datum, called a balance datum, said plurality of lists comprising at least a first list with at least one item comprising at least one datum, called an action datum, and at least one datum, called an amount datum, said action datum being associated with at least one action, wherein the managing comprises:
triggering said at least one action associated with said action datum of an item of said at least one first list;
adding at least one first new item in said first list of items and at least one second new item in at least one second list of items of said plurality;
calculating, as a function of said action, a new value of said amount datum of said at least one first new item of said first list of items, a new value of said amount datum of said at least one second new item of said at least one second list of items of said plurality, a new value of said balance datum of said first list of items and a new value of said balance datum of said at least one second list of items of said plurality; and
updating said balance datum of said first list of items, said balance datum of said at least one second list of items of said plurality, said amount datum of said at least one second new item of said at least one second list of items of said plurality and said amount datum of said at least one first new item of said first list of items.

2. The method as claimed in claim 1, wherein the triggering is followed by rendering, to a user, a set of data to be selected, called selection data, and a selection, by said user, of one of the selection data.

3. The method as claimed in claim 2, wherein the selection of one said selection datum by said user is performed via a voice command.

4. The method as claimed in claim 1, wherein the rendering of the lists of items is performed through a human-machine interface displayed on a screen of said terminal.

5. The method as claimed in claim 4, wherein said screen of said terminal is a touchscreen and the triggering is performed via a press on said at least one action datum of said item of said at least one first list displayed on said screen.

6. The method as claimed in claim 4, wherein said screen of said terminal is a touchscreen and the triggering is performed via a drag/drop of said item of said at least one first list displayed on said screen to an element of said human-machine interface symbolizing said at least one second list of items.

7. The method as claimed in claim 1, wherein the rendering of the lists of items is performed via vocalization.

8. The method as claimed in claim 1, wherein the triggering is performed via a voice command.

9. The method as claimed in claim 1, wherein said plurality of lists of items corresponds to a plurality of lists of banking operations.

10. The method as claimed in claim 9, wherein said at least one action associated with said at least one action datum of an item of said first list of items is a bank transfer.

11. The method as claimed in claim 9, wherein said at least one action associated with said at least one action datum of an item of said first list of items is a bank withdrawal.

12. A device comprising:
at least one processor; and
at least one non-transitory computer readable medium comprising instructions stored thereon which when executed by the at least one processor configure the device to manage a plurality of lists of items, each list of items of said plurality being different from all subsets of another list of items of said plurality and comprising at least one datum, called a balance datum, said plurality of lists comprising at least one first list with at least one item comprising at least one datum, called an action datum, and at least one datum, called an amount datum, said action datum being associated with at least one action, wherein the managing comprises:
triggering said at least one action associated with said action datum of an item of said at least one first list;
adding at least one first new item in said first list of items and at least one second new item in at least one second list of items of said plurality;
calculating, as a function of said action, a new value of said amount datum of said at least one first new item of said first list of items, a new value of said amount datum of said at least one second new item of said at least one second list of items of said plurality, a new value of said balance datum of said first list of items and a new value of said balance datum of said at least one second list of items of said plurality; and
updating said balance datum of said first list of items, said balance datum of said at least one second list of items of said plurality, said amount datum of said at least one second new item of said at least one second list of items of said plurality and said amount datum of said at least one first new item of said first list of items.

13. A terminal comprising the device for managing a plurality of lists of items as claimed in claim 12.

14. A non-transitory computer-readable medium comprising a computer program stored thereon comprising instructions which when executed by a processor of a terminal configure the terminal to implement a method of managing a plurality of lists of items that can be rendered by said terminal, each list of items of said plurality being different from all subsets of another list of items of said plurality and comprising at least one datum, called a balance datum, said plurality of lists comprising at least a first list with at least one item comprising at least one datum, called an action datum, and at least one datum, called an amount datum, said action datum being associated with at least one action, wherein the managing comprises:
triggering said at least one action associated with said action datum of an item of said at least one first list;
adding at least one first new item in said first list of items and at least one second new item in at least one second list of items of said plurality;
calculating, as a function of said action, a new value of said amount datum of said at least one first new item of said first list of items, a new value of said amount datum of said at least one second new item of said at least one second list of items of said plurality, a new value of said balance datum of said first list of items and a new value of said balance datum of said at least one second list of items of said plurality; and
updating said balance datum of said first list of items, said balance datum of said at least one second list of items of said plurality, said amount datum of said at least one second new item of said at least one second list of items of said plurality and said amount datum of said at least one first new item of said first list of items.
